(19) United States
(12) Patent Application Publication
(10) Pub. No.: US 2021/0304664 A1
(43) Pub. Date: Sep. 30, 2021

(54) DISPLAY DEVICE AND DISPLAY SYSTEM

(71) Applicant: BOE TECHNOLOGY GROUP CO., LTD., Beijing (CN)

(72) Inventors: Jinlei LI, Beijing (CN); Xin LI, Beijing (CN)

(21) Appl. No.: 17/194,212

(22) Filed: Mar. 6, 2021

(30) Foreign Application Priority Data
Mar. 25, 2020 (CN) 202020399775.1

(51) Int. Cl. G09G 3/32

(52) U.S. Cl. CPC G09G 3/32; G09G 2360/10; G09G 2370/16

(57) ABSTRACT

The present disclosure relates to the field of display, and proposes a display device and a display system. The display device comprises a display panel, a first processor, a second processor, a first signal transceiver, and a second signal transceiver. The first processor is electrically connected to the display panel, and is configured to process multimedia files. The second processor is electrically connected to the display panel, and is configured to process communication data, control instructions, and feedback information. The second processor is electrically connected to the first processor. The first signal transceiver is electrically connected to the first processor, and is configured to receive the multimedia files. The second signal transceiver is electrically connected to the second processor, and is configured to receive the communication data and the control instructions, as well as to send feedback information.

### CROSS-REFERENCE TO RELATED APPLICATION(S)

The present application claims priority to Chinese Patent Application No. 202020399775.1 filed on Mar. 25, 2020, the entirety of which is incorporated herein by reference in its entirety.

### TECHNICAL FIELD

The present disclosure relates to the field of display and, in particular, to a display device and a display system comprising the display device.

### BACKGROUND

Transparent light-emitting diode (LED) display technology has become increasingly mature, and transparent LED display control systems are widely used in traffic, advertising, news releases, sport games, large concerts, and other fields. The transparent LED display control system, being essential to control display data and images of a LED screen, is the core of the entire LED display system. The current application processor of a display device is poor in real-time response, and the Micro Control Unit (MCU) based on a real-time operating system has poor processing performance, low rates, and small memory.

Therefore, there is a need for a new display device and a display system comprising such new display device.

The above information disclosed in the background section is intended only to enhance understanding the background of the present disclosure, and therefore it may comprise information that does not constitute prior art known to those of ordinary skill in the art.

### SUMMARY

According to an aspect of the present disclosure, there is provided a display device, comprising:
a display panel;
a first processor, electrically connected to the display panel and configured to process multimedia files;
a second processor, electrically connected to the display panel and configured to process communication data, control instructions and feedback information, wherein the second processor is electrically connected to the first processor;
a first signal transceiver, electrically connected to the first processor and configured to receive the multimedia files; and
a second signal transceiver, electrically connected to the second processor and configured to receive the communication data and the control instructions, and to send the feedback information.

In an exemplary embodiment of the present disclosure, the display device further comprising:
a first memory, electrically connected to the first processor and configured to store the multimedia files; and
a second memory, electrically connected to the first memory and configured to read and store at least part of the multimedia files from the first memory in response to receiving the control instructions.

In an exemplary embodiment of the present disclosure, the first memory comprises a dual-rate synchronous dynamic random memory and the second memory comprises a NAND flash memory.

In an exemplary embodiment of the present disclosure, the display device further comprises a power supply assembly, wherein the power supply assembly is electrically connected to the second signal transceiver, the display panel, the first processor, and the second processor.

In an exemplary embodiment of the present disclosure, the power supply assembly comprises:
a power converter, electrically connected to the second signal transceiver, the display panel, the first processor and the second processor;
a battery, electrically connected to the power converter; and
a battery indicator, electrically connected to the battery.

In one exemplary embodiment of the present disclosure, the display panel comprises a Light-Emitting Diode screen.

In one exemplary embodiment of the present disclosure, the first processor comprises a dual Cortex-A7 core and the second processor comprises a Cortex-M4 core.

In an exemplary embodiment of the present disclosure, the first signal transceiver comprises a thin film 4G signal antenna; and the second signal transceiver comprises a LoRa signal antenna and a LoRa wireless module, wherein the LoRa signal antenna is electrically connected to the LoRa wireless module, and the LoRa wireless module is electrically connected to the second processor.

In an exemplary embodiment of the present disclosure, the first processor has a built-in embedded Android operating system, and the second processor has a built-in embedded RTOS operating system.

According to an aspect of the present disclosure, there is provided a display system, comprising:
a plurality of display devices as described in any one of the above.

In an exemplary embodiment of the present disclosure, the display system further comprises:
a first workstation, configured to send the multimedia files to the first signal transceiver via a 4G base station; and
a second workstation, configured to send the communication data and the control instructions to the second signal transceiver via a LoRa base station, and to receive the feedback information from the second signal transceiver.

### BRIEF DESCRIPTION OF THE DRAWINGS

These and other features and advantages of the present disclosure will become more apparent from a detailed description of exemplary embodiments thereof with reference to the accompanying drawings.

FIG. 1 is a schematic structrual diagram of the display device according to an example embodiment of the present disclosure.

FIG. 2 is a schematic structrual diagram of the display system according to an example embodiment of the present disclosure.

### DETAILED DESCRIPTION OF THE EMBODIMENTS

Example embodiments will now be described more fully with reference to the accompanying drawings. However, the example embodiments can be implemented in a variety of forms and should not be construed as being limited to the embodiments set forth herein. Rather, the provision of these embodiments makes the present disclosure comprehensive and complete, and conveys the idea of the example embodiments in a comprehensive manner to those skilled in the art. The same accompanying markings in the figures indicate the same or similar structures, and thus their detailed description will be omitted.

In the related art, the display device mainly adopts an Android Operating System (OS). For an Android operating system, in addition to meeting the application function requirements, it is more important to meet the real-time requirements put forward by the application, while the real-time requirements of many real-time tasks composing an application function are different. In addition, there may be some complex association and synchronization relationships between real-time tasks, such as execution order restrictions, mutual exclusion access requirements for shared resources, and so on. This brings great difficulties to guarantee the real-time performance of the system. Therefore, Android OS can only use various algorithms and strategies to ensure the predictability of system behaviors. For some scenarios with strict real-time requirements, such as audio and video synchronization and other multimedia playback scenarios, it is more difficult for an Android system to achieve low latency through software algorithms

Also, in Android OS, most external interrupts are turned on and interrupt handling is generally done by the device driver. Since user processes in Android OS generally have no real-time requirement, and interrupt handlers interact directly with hardware devices, the priority of interrupt handlers is set higher than any user processe. However, for an Android system, it does not respond to external interrupts in a timely manner, resulting in poor real-time performance.

The transparent LED display system comprises an upper computer, a controller, a driver, video playback management software, and a communication system. The upper computer is configured to send video files through the wired or wireless mechanism, and to implement unified play through the control system. Due to many restrictions such as the overall structure and the signaling mechanism, it is difficult to achieve a visual effect of dynamic display, or 3D display.

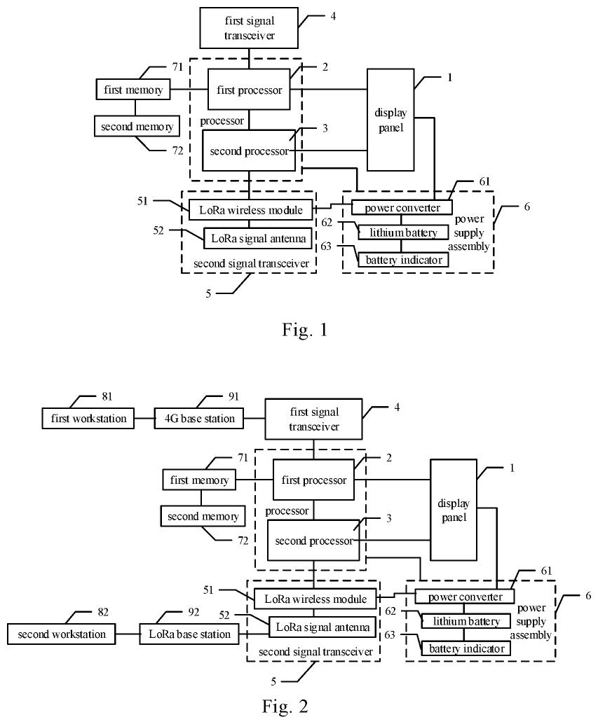

The present disclosure first provides a display device. With reference to a schematic structural diagram of the display device according to an example implementation of the present disclosure shown in FIG. 1, the display device may comprise a display panel 1, a first processor 2, a second processor 3, a first signal transceiver 4, and a second signal transceiver 5. The first processor 2 is electrically connected to the display panel 1, and configured to process multimedia files. The second processor 3 is electrically connected to the display panel 1, and configured to process communication data, control instructions and feedback information. The first signal transceiver 4 is electrically connected to the first processor 2, and configured to receive the multimedia files. The second signal transceiver 5 is electrically connected to the second processor 3, and configured to receive the communication data and the control instructions, and also to send the feedback information. The first processor 2 and the second processor 3 may be connected via a bus.

The display device receives the multimedia files by the first signal transceiver 4 and processes the multimedia files by the first processor 2. Further, the display device receives the communication data and the control instructions and sends the feedback information by the second signal transceiver 5, and further processes the communication data, the control instructions, and the feedback information by the second processor 3. Processing of the multimedia files and processing of the communication data, the control instructions, and the feedback information are carried out in two ways so as to improve the real-time processing performance of the communication data, the control instructions, and the feedback information, and also to avoid problems such as poor processing performance and low rate of the Micro Controller Unit (MCU) in an existing real-time operating system.

In an example implementation, the display panel 1 may be a Light-Emitting Diode (LED) transparent foldable screen. As may be apparent, in other example implementations of the present disclosure, the display panel 1 can also be an ordinary light-emitting diode screen, an Organic Light-Emitting Diode (OLED) screen or a Liquid Crystal Display (LCD) screen.

In an example implementation, the first processor 2 is a dual ArmCortex-A7 core running at a frequency of 650 MHz. The first processor 2 has a built-in embedded Andriod operating system for handling multimedia files, for example, complex video playing, high-capacity data caching, and other multimedia play functions. The biggest advantage of the Andriod platform is its openness, which is compatible with rich software resources. In addition, the first processor 2 can also be Allwinner A31.

In an example implementation, the second processor 3 is a Cortex-M4 core running at a frequency of 209 MHz. The second processor 3 has a built-in embedded RTOS operating system for processing communication data, control instructions and feedback information, and for quickly responding to control instructions sent by the second signal transceiver 5. The communication data can comprise synchronization frames, Protocol Data Unit (PDU), Cyclic Redundancy Check (CRC), AES128 key. The control instructions can comprise start, stop, close, etc. The feedback information can comprise OK, return, cancel, close, open, etc. for input through the display device. The embedded RTOS operating system is stored in firmware and runs on a baseband processor. The RTOS operating system is simpler, more reliable, and improves the system's real-time performance. For the RTOS operating system running on the Cortex-M4 core, the external hardware interrupts have a higher priority than any other task. Thus, when the system receives an external hardware interrupt, the content of the currently executing task is interrupted and parameter pointers, etc.

are stored in the stack, thereby giving priority to respond to the external interrupt. This ensures the real-time nature of the burst mechanism, where the thread of the original task can be resumed after processing the interrupt. In addition, the second processor 3 can also be STM32L476.

Firmware is a program written in an erasable programmable read-only memory (EPROM) or an electrically erasable programmable read-only memory (EEPROM). The baseband processor is an important component for a cell phone, equivalent to a protocol processor, and responsible for data processing and storage. The main components are a digital signal processor (DSP), a microcontroller unit (MCU), a memory (SRAM, Flash, etc.), and other units. The main functions are to support several communication standards, to provide multimedia functions, and to be used in interfaces related to multimedia displays, image sensors, and audio devices.

The Cortex-A7 core and the Cortex-M4 core form a dynamically efficient system, where the Cortex-A7 core and the Cortex-M4 core can run or stop independently for optimal performance, so as to meet a variety of processing requirements and real-time application requirements. Standby mode is as low as 36uW, which is low power consumption as compared to other application processors.

The Android system based on Cortex-A7 processor has rich software resources that can be used to improve the efficiency of processing multimedia files. The RTOS real-time operating system based on Cortex-M4 processor can provide fast response for processing communication data, control instructions, and feedback information, so as to improve real-time performances of the system. In addition, the display device can be equipped with a dedicated 3D graphics processing unit (GPU), a MIPI-DSI display interface, and a CANFD interface.

In an example implementation, the first signal transceiver 4 may be a thin film 4G signal antenna. The first signal transceiver 4 may also be a 5G signal antenna, a WIFI signal antenna, etc. The second signal transceiver 5 may comprise a LoRa signal antenna 52 and a LoRa wireless module 51, where the LoRa signal antenna 52 is electrically connected to the LoRa wireless module 51, and the LoRa wireless module 51 is electrically connected to the second processor 3.

In an example implementation, the display device may further comprise a first memory 71 and a second memory 72, where the first memory 71 is electrically connected to the first processor 2, the first memory 71 being used to store multimedia files and the second memory 72 is electrically connected to the first memory 71. Besides, the second memory 72 is configured to read and store at least a portion of the multimedia files from the first memory in response to receiving the control instructions.

In an example implementation, the display device may also comprise a power supply assembly electrically connected to the second signal transceiver 5, the display panel 1, the first processor 2, and the second processor 3. The power supply assembly is used to power the entire display device. Specifically, the power supply assembly may comprise a power converter 61, a battery, and a battery indicator 63. The power converter 61 is electrically connected to the LoRa wireless module 51 of the second signal transceiver 5, the display panel 1, the first processor 2, and the second processor 3. The first signal transceiver 4 is powered through the first processor 2. The power converter 61 is capable of converting the voltage from the battery into the voltage required by the second signal transceiver 5, the display panel 1, the first processor 2, and the second processor 3. The battery is electrically connected to the power converter 61. The battery may be a rechargeable lithium battery 62 that can be connected to an external power adapter for charging. The battery indicator 63 is electrically connected to the battery, and the battery indicator 63 can display the real-time electric quantity of the battery through the display panel 1, so as to remind the user to recharge in time.

Further, the present disclosure also provides a display system. Referring to the schematic structural diagram of the display system according to an example implementation of the present disclosure shown in FIG. 2, the display system comprises a plurality of display devices as described above. The plurality of display devices are required to display the same content simultaneously, or the plurality of display devices are required to perform simultaneous display so as to form a whole picture or video. The structure of the display device has been described in detail above, so it will not be repeated here.

The display system may further comprise a first workstation 81 and a second workstation 82, where the first workstation 81 communicates with the first signal transceiver 4 via a 4G base station 91 or a 5G base station, so as to send the multimedia files to the first processor 2 via the first signal transceiver 4. The second workstation 82 communicates with the second signal transceiver 5 via the

LoRa base station 92, so as to send the communication data and the control instructions to the second processor 3 via the second signal transceiver 5. Alternatively, the second workstation 82 receives the feedback information, input by the user on the display device, via the second signal transceiver 5 and the second processor 3. The first workstation 81 and the second workstation 82 may be a computer, an industrial control machine, etc. Transmission between the workstation and the base station can be wired or wireless. Transmission between the base station and the display device can be wired or wireless.

The specific working process of the display system is as follows.

The first workstation 81 sends large-capacity multimedia files to each display device through a high-speed communication channel such as 4G or WIFI. The Android system (i.e., the first processor 2) of each display device receives the multimedia files and stores packets of the multimedia files in DDR memory (i.e., the first memory 71). The display device is then ready to receive control instructions. The second workstation 82 sends the control instructions through a LoRa wireless network, where the control instructions can be sent in five consecutive re-transmissions with an interval time of 1 second, and a private network can be used to ensure that there is no signal interference at site, so as to ensure that each display terminal receives the control instructions. After the display device receives the control instructions, the multimedia data stored in the first memory 71 above is read into the NAND flash memory (i.e., the second memory 72). The time is synchronized while receiving the control instructions as described above, so as to ensure a uniform display of all display devices after the synchronization information is determined.

The display system according to the present disclosure uses a real-time LoRa network having low power consumption to issue control instructions, where all nodes (i.e., all display devices) and gateways have the same communication parameter setting. Besides, in order to prevent communication conflicts between nodes, time division multiplexing is used for message communication. In order to reduce power consumption, the second processor is in sleep mode for a long time and wakes up work at regular intervals. When a node listens to a command frame sent by the base station, the system enters the synchronization mechanism. When it does not listen to any command frame, the LoRa module (i.e., the LoRa wireless module 51 and the LoRa signal antenna 52) hops in frequency to search for command frames on other channels. When no command frame is received on all channels during the wake-up cycle, the node is in an offline state and enters deep sleep mode. The display system according to the present disclosure has low power consumption and can be adapted to situations having high real-time requirements.

The features, structures, or characteristics described above may be combined in any suitable manner in one or more embodiments, and the features discussed in the various embodiments are interchangeable, if possible. In the above description, many specific details are provided thereby giving a full understanding of embodiments of the present disclosure. However, those of skills in the art will realize that it is possible to practice the technical embodiments of the present disclosure without one or more of the specific details described, or that other methods, components, materials, etc. may be employed. In other instances, well-known structures, materials, or operations are not shown or described in detail to avoid obscuring aspects of the present disclosure.

In the present specification, the terms “a”, “a”, “the”, and “said” are used to indicate the presence of one or more elements, components, etc. The terms “contains”, “includes”, and “has” are used to indicate an open-ended inclusion and refer to the existence of additional elements, components, etc. in addition to those listed. The terms “contains”, “includes”, and “has” are used to indicate the existence of additional elements, components, etc. in addition to those listed. The terms “first”, “second”, and “third” are used only as indicia and are not quantitative restrictions on their objects. The terms “first”, “second”, and “third” are used as markers only and are not quantitative restrictions on their objects.

It is to be understood that the present disclosure does not limit its application only to the detailed construction and arrangement of the components presented in the present specification. The present disclosure can have other embodiments, and can be implemented and performed in a variety of ways. The foregoing variations and modifications fall within the scope of the present disclosure. It is to be understood that the present disclosure as disclosed and limited by the present specification extends to all alternative combinations of two or more individual features mentioned or apparent in the text and/or the accompanying drawings. All such different combinations constitute multiple alternative aspects of the present disclosure. The embodiments described in the present specification illustrate the best manner known for implementing the present disclosure and will enable those skilled in the art to utilize the present disclosure.

### LIST OF REFERENCE NUMERALS

1 display panel

2 first processor

3 second processor

4 first signal transceiver

5 second signal transceiver

51 LoRa wireless modules

52 LoRa signal antenna

6 power supply assembly

61 power converter

62 lithium battery

63 battery indicator

71 first memory

72 second memory

81 first workstation

82 second workstation

91 4G base station

92 LoRa base station

1. A display device, comprising:
a display panel;
a first processor electrically connected to the display panel and configured to process multimedia files;
a second processor electrically connected to the display panel and configured to process communication data, control instructions, and feedback information, wherein the second processor is electrically connected to the first processor;
a first signal transceiver electrically connected to the first processor and configured to receive the multimedia files; and
a second signal transceiver electrically connected to the second processor, and configured to receive the communication data and the control instructions, and to send the feedback information.

2. The display device according to claim 1, further comprising:
a first memory electrically connected to the first processor and configured to store the multimedia files; and
a second memory electrically connected to the first memory, and configured to read and store at least part of the multimedia files from the first memory in response to receiving the control instructions.

3. The display device according to claim 2, wherein the first memory comprises a double-rate synchronous dynamic random memory and the second memory comprises a NAND flash memory.

4. The display device according to claim 1, further comprising:
a power supply assembly electrically connected to the second signal transceiver, the display panel, the first processor and the second processor.

5. The display device according to claim 4, wherein the power supply assembly comprises:
a power converter, electrically connected to the second signal transceiver, the display panel, the first processor and the second processor;
a battery, electrically connected to the power converter.; and
a battery indicator, electrically connected to the battery.

6. The display device according to claim 1, wherein the display panel comprises a Light-Emitting Diode screen.

7. The display device according to claim 1, wherein the first processor comprises a dual Cortex-A7 core and the second processor comprises a Cortex-M4 core.

8. The display device according to claim 1, wherein
the first signal transceiver comprises a thin film 4G signal antenna, and
the second signal transceiver comprises a LoRa signal antenna and a LoRa wireless module, wherein the LoRa signal antenna is electrically connected to the LoRa wireless module, and the LoRa wireless module is electrically connected to the second processor.

9. The display device according to claim 1, wherein the first processor has a built-in embedded Android operating system and the second processor has a built-in embedded RTOS operating system.

10. A display system, comprising:
a plurality of display devices, wherein each display devices comprises:
a display panel;
a first processor, electrically connected to the display panel and configured to process multimedia files;
a second processor, electrically connected to the display panel and configured to process communication data, control instructions and feedback information, wherein the second processor is electrically connected to the first processor;
a first signal transceiver, electrically connected to the first processor and configured to receive the multimedia files; and
a second signal transceiver, electrically connected to the second processor, and configured to receive the communication data and the control instructions, and to send the feedback information.

11. The display system according to claim 10, further comprising:
a first workstation, configured to send the multimedia files to the first signal transceiver via a 4G base station; and
a second workstation, configured to send the communication data and the control instructions to the second signal transceiver via a LoRa base station, and to receive the feedback information from the second signal transceiver.

12. The display system according to claim 10, wherein each display device further comprises:
a first memory, electrically connected to the first processor and configured to store the multimedia files; and
a second memory, electrically connected to the first memory and configured to read and store at least part of the multimedia files from the first memory in response to receiving the control instructions.

13. The display system according to claim 12, wherein the first memory comprises a double-rate synchronous dynamic random memory and the second memory comprises a NAND flash memory.

14. The display system according to claim 10, wherein each display device further comprises a power supply assembly, the power supply assembly being electrically connected to the second signal transceiver, the display panel, the first processor and the second processor.

15. The display system according to claim 14, wherein the power supply assembly comprises:
a power converter, electrically connected to the second signal transceiver, the display panel, the first processor and the second processor;
a battery, electrically connected to the power converter; and
a battery indicator, electrically connected to the battery.

16. The display system according to claim 10, wherein the display panel comprises a Light-Emitting Diode screen.

17. The display system according to claim 10, wherein the first processor comprises a dual Cortex-A7 core and the second processor comprises a Cortex-M4 core.

18. The display system according to claim 10, wherein
the first signal transceiver comprises a thin film 4G signal antenna, and
the second signal transceiver comprises a LoRa signal antenna and a LoRa wireless module, wherein the LoRa signal antenna is electrically connected to the LoRa wireless module, and the LoRa wireless module is electrically connected to the second processor.

19. The display system according to claim 10, wherein the first processor has a built-in embedded Android operating system and the second processor has a built-in embedded RTOS operating system.
